(19) United States
(12) Patent Application Publication
(10) Pub. No.: US 2007/0041795 A1
(43) Pub. Date: Feb. 22, 2007

(54) Device for the mixing, drying and coating of powdered, granular or moulded bulk material in a fluid bed and method for production of supported catalysts with such a device

(75) Inventors: Samuel Neto, Mannheim (DE); Wolfgang Rummel, Koln (DE); Sebastian Storck, Mannheim (DE); Jurgen Zuhlke, Speyer (DE); Frank Rosowski, Mannheim (DE)

Correspondence Address: CONNOLLY BOVE LODGE & HUTZ, LLP, P O BOX 2207, WILMINGTON, DE, 19899, US

(73) Assignee: BASF Aktiengesellschaft Patents, Trademarks and Licenses, Ludwigshafen (DE)

(21) Appl. No.: 10/573,479

(22) PCT Filed: Sep. 24, 2004
(86) PCT No.: PCT/EP04/10748

§ 371 Date: Mar. 24, 2006

(30) Foreign Application Priority Data
Sep. 26, 2003 (DE) 103 44 845.4

(51) Int. Cl. B65G 53/40

(52) U.S. Cl. 406/117

(57) ABSTRACT

The invention relates to an apparatus for mixing, drying and coating pulverulent, granular or shaped loose material in a fluidized bed, in particular for use in a process for producing supported catalysts for gas-phase oxidations, which comprises a container (10) for accommodating the loose material, with a bowl-like depression (17) being provided in a lower region (13) of the container (10), a central tube (27) for introducing a gas, with the central tube entering the container in an upper region (12) of the container (10), extending essentially axially downward in the container (10) and opening into the depression (17), an essentially annular deflection shield (29) which is fixed to the central tube (27) in the upper region (12) of the container (10), a guide ring (31) which is located in the lower region (13) of the container (10) and surrounds the central tube (27) essentially concentrically at a distance (L) for part of its length so that a first opening (34) is formed between the wall of the container (10) at the upper edge (22) of the depression and the lower end (33) of the guide ring (31) and a second opening (36) is formed between the deflection shield (29) and the upper edge (35) of the guide ring (31), and means, for example valves (21), for introducing a fluid into the container (10). In the apparatus of the present invention, the outer wall of the central tube (27) is at least partly provided with an adhesion-reducing coating (38). In a preferred embodiment, the distance (L) between the wall of the central tube (27) and the wall of the guide ring (27) is greater than the open height (H3) of the first opening (34). The invention also provides a process for producing supported catalysts using such an apparatus.

The present invention relates to an apparatus for mixing, drying and coating pulverulent, granular or shaped loose material in a fluidized bed and a method of producing supported catalysts using such an apparatus, in particular a method of producing supported catalysts for gas-phase oxidations.

Many carboxylic acids and/or carboxylic anhydrides are prepared industrially by catalytic gas-phase oxidation of aromatic hydrocarbons such as benzene, the xylenes, naphthalene, toluene or durene in fixed-bed reactors. In this way, it is possible to obtain, for example, benzoic acid, maleic anhydride, phthalic anhydride, isophthalic acid, terephthalic acid or pyromellitic anhydride. In general, a mixture of an oxygen-containing gas and the starting material to be oxidized is passed through tubes in which a bed of a catalyst is present. To regulate the temperature, the tubes are surrounded by a heat transfer medium, for example a salt melt.

As catalysts for these oxidation reactions, it has been found to be useful to employ coated catalysts in which the catalytically active composition has been applied in the form of a shell to an inert support material such as steatite. The catalytically active constituents of the catalytically active composition of these coated catalysts are generally titanium dioxide and vanadium pentoxide. Furthermore, small amounts of many other oxidic compounds which act as promoters to influence the activity and selectivity of the catalyst can be present in the catalytically active composition.

To produce such coated catalysts, an aqueous suspension of the constituents of the active composition and/or their precursor compounds or sources of them are sprayed onto the support material at elevated temperature until the weight of the active composition corresponds to the desired proportion of the total weight of the catalyst. Fluidized-bed apparatuses are particularly useful for this purpose. In these apparatuses, the support material is fluidized in an ascending gas stream, in particular air. The apparatuses usually comprise a conical or spherical container in which the fluidizing gas is introduced from below or from the top via a central tube or tube dipping down to near the bottom. The suspension is sprayed into the fluidized bed via nozzles from the top, from the side or from the bottom.

DE-A 8 72 928 describes a fluidized-bed apparatus which comprises a cylindrical container having a tapering lower part which ends in a bucket-shaped section. The container is closed at the top by means of a lid through which a tube passes and projects down into the bucket section. In the upper part of the container, the downward-projecting tube is surrounded by an umbrella-shaped impingement plate. The downward-projecting tube is enclosed by an outer tube having a greater diameter but a lesser length which likewise projects into the bucket-shaped section cf the container but ends at a distance from the impingement shield. Another impingement plate is installed at a distance from the lower end of the downward-projecting tube. In this apparatus, the air blown in through the downward-projecting tube is blown out in an upward direction through the outer tube and is deflected outward by the impingement shield. The particulate material is conveyed through the constricting lower part of the container onto the lower impingement plate and is carried into the outer tube by the air stream. A disadvantage of this apparatus is the only moderate fluidization of the particulate material and the associated risk of a blockage of the lower opening of the outer tube. In particular, damage and attrition of the particulate material can occur as a result of the small distance between the upper edge of the outer tube and the impingement shield.

EP-A 1 03 894 describes a fluidized-bed apparatus comprising a rotationally symmetric container which has a diameter decreasing in the downward direction and whose lower part opens into a bowl. A tube projects axially down from the top into the bowl, so that a narrow annular gap is formed between the downward-projecting tube and the bowl wall. A deflection shield is arranged in the upper third of the downward-projecting tube. In this fluidized-bed apparatus, the gas stream exiting from the annular gap upward into the container carries the material upward all around the downward-projecting tube, and the material is deflected outward by the deflection shield and travels downward along the converging inner wall of the lower part of the container back to the vicinity of the bowl from where the material is once again carried upward around the downward-projecting tube. This results in uniform circulation of the material in the container. If the flow velocity of the gas is sufficient, this circulation can even take the form of complete fluidization of the material. A disadvantage of this type of fluidization is that a considerable part of the kinetic energy of the gas stream has to be used to overcome frictional forces between the stream ascending along the downward-projecting tube and particulate material flowing inward from the side. In the case of relatively large apparatuses and bed heights and in the case of impact-sensitive material, for example ceramic rings, this leads to an undesirable proportion of broken material.

A fluidized-bed apparatus which overcomes these disadvantages is the apparatus described in DE-A 40 06 935 which has the features of the preamble of the present claim 1. The known apparatus comprises a spherical container which goes over in its lower part into a bowl-like depression and a central tube which extends axially downward in the container and ends in the depression, with an annular deflection shield being fixed to the central tube within the upper part of the container, and has, within the lower part of the container, a guide ring which has a greater diameter than the central tube and is arranged concentrically to the central tube so that a first annular opening is left free between the transition from the lower part of the container to the bowl-like depression and a second annular opening is left free between the deflection shield and the guide ring. The diameter of the guide ring is greater than or equal to the diameter of the bowl-shaped depression. Furthermore, the diameter of the guide ring is smaller than or equal to the free height of the first opening. The height of the guide ring itself is in the range from ⅓ to ⅔ of the total height between the underside of the first opening and the top of the second opening. In this apparatus, the fluidized material is conveyed upward between the guide ring and the central tube by means of the gas jet introduced through the central tube until it is deflected by the deflection shield, while the particulate material which is present in the space between the guide ring and the container wall travels under the force of gravity into the first annular opening between the bottom edge of the guide ring and the lower part of the container and is there fluidized again and conveyed upward by the gas stream. The separation of the descending particulate material from the fluidized, upward-moving particles by means of the guide ring within the lower part of the container results in a significant reduction in the frictional and impact forces exerted on the particles, so that the circulation of the material occurs significantly more quickly, more thoroughly and more gently in the presence of the guide ring than without the guide ring in an otherwise identical procedure. Thus, satisfactory fluidization with a lower proportion of broken material can be achieved with a reduced amount of transport gas under significantly milder conditions compared to apparatuses which do not contain a guide ring.

A disadvantage of the fluidized-bed apparatus of DE-A 40 06 935 is that a deposit is formed on the central tube and other components during operation, so that costly cleaning of the interior of the container is necessary after seven or eight coating processes. Furthermore, support materials, in particular rings, having an external diameter of more than 7 mm cannot be coated uniformly by means of the known apparatus.

It is an object of the present invention to provide a fluidized-bed apparatus for mixing, drying and coating pulverulent, granular or shaped loose material, in particular catalyst supports, in a fluidized bed, which allows longer operating times and which makes it possible for even relatively large catalyst supports to be coated uniformly. Another object of the invention is to provide a method of producing supported catalysts using such an apparatus.

We have found that this object is achieved by the apparatus as claimed in the present claim 1. Advantageous embodiments are disclosed in the dependent claims.

The present invention provides an apparatus for mixing, drying and coating pulverulent, granular or shaped loose material in a fluidized bed, which comprises a container for accommodating the loose material, with a bowl-like depression being provided in a lower region of the container, a central tube for introducing a gas, with the central tube entering the container in an upper region of the container, extending essentially axially downward in the container and opening into the depression, an essentially annular deflection shield which is fixed to the central tube in the upper region of the container, a guide ring which is located in the lower region of the container and surrounds the central tube essentially concentrically at a distance L for part of its length so that a first opening is formed between the wall of the container at the upper edgy of the depression and the lower end of the guide ring and a second opening is formed between the deflection shield and the upper edge of the guide ring, and means for introducing a fluid, preferably a suspension, into the container, where the suspension preferably comprises a catalytically active material or a precursor or source thereof. In the apparatus of the present invention, the outer wall of the central tube, preferably the region of the outer wall below the deflection shield, is at least partly provided with an adhesion-reducing coating.

Coating of the outer wall of the central tube drastically reduces deposit formation. Only after about 15 coating processes does appreciable disturbance of the air flow in the container occur, thus making cleaning necessary. In customary coating processes, this means that cleaning is only required once a day instead of at least twice a day as has been the case hitherto. Furthermore, the adhesion-reducing coating simplifies cleaning of the interior of the container. Overall, the apparatus of the present invention makes it possible to increase the daily production capacity by more than 20%.

The guide ring is usually fixed to the central tube via struts. In this case, the struts are preferably also provided with the adhesion-reducing coating.

The underside of the deflection shield and/or the inside wall of the guide ring are preferably also provided with the adhesion-reducing coating in order to achieve a further reduction in deposit formation and the associated impairment of the air flow.

It is possible to use any adhesion-reducing coatings which are inert under the operating conditions of the apparatus. The adhesion-reducing coating is preferably a polymer of a fluorinated, preferably perfluorinated, ethylenically unsaturated hydrocarbon, for example a fluoropolymer such as polytetrafluoroethylene. However, it is also possible to use ceramic materials or composite materials which are filled with graded ceramic, stainless steel or polymer particles and provide a high level of abrasion protection in addition to the adhesion-reducing action.

In a preferred embodiment of the apparatus of the present invention, the distance between the wall of the central tube and the wall of the guide ring is greater than the open height of the first opening. Such an arrangement allows relatively large support materials, for example supports having diameters of 8 mm and more, to be coated uniformly either with one layer or with two layers. Furthermore, the support material can be coated with a higher density.

The distance between the wall of the central tube and the wall of the guide ring is preferably less than ⅔ of the diameter of the deflection shield. This diameter is particularly preferably less than half the diameter of the deflection shield.

The distance between the wall of the central tube and the wall of the guide ring is advantageously matched to the dimensions of the loose or particulate material, with a correspondingly larger distance within the above-described limits being chosen in the case of larger particle sizes of the material.

The height of the guide ring is preferably in the range from one third to two thirds of the distance between the upper edge of the depression and the central axis of the container.

The external diameter of the guide ring preferably corresponds essentially to half the diameter of the container, which ensures effective circulation of the particulate material, i.e., for example, the support material.

The present invention further provides a method of producing supported catalysts, which comprises fluidizing the catalyst supports in the apparatus of the present invention and coating them by spraying them with a catalyst-containing suspension. The method of the present invention is preferably used for producing supported catalysts for the synthesis of benzoic acid, maleic anhydride, phthalic anhydride, isophthalic acid, terephthalic acid or pyromellitic anhydride by gas-phase oxidation.

The invention is illustrated below with reference to an embodiment of the apparatus of the present invention depicted in the attached drawing.

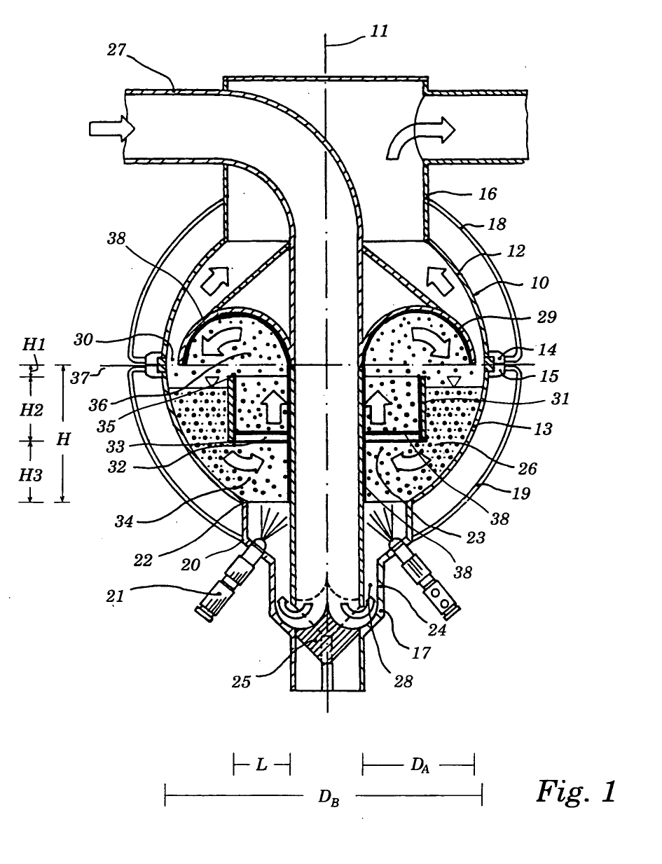

In the drawing, FIG. 1 schematically shows a longitudinal section through a fluidized-bed apparatus according to the present invention for coating catalyst supports.

The apparatus for coating catalyst supports in a fluidized bed comprises a spherical container 10 having an internal diameter D_{B} and is rotationally symmetric around a vertical container axis 11. The container 10 has an upper part 12 and a lower part 13, which in the depicted example each have the shape of part of a sphere and are preferably made of glass or steel. The two parts 12, 13 of the container are joined at their circumference by means of a flange 14, 15.

The upper part 12 of the container is superposed by an attachment 16, while the lower part 13 of the container goes over at the bottom into a bowl-like depression 17. Two yokes 18 and 19 are attached to the superposed attachment 16 and the depression 17 and are clipped together, for example by means of customary self-centering clips or similar quick-release fastenings, so as to allow the parts 12,13 of the container to be taken apart quickly for cleaning. In this state, it is usual for either the upper part 12 of the container to be supported via the superposed attachment 16 by a bearer structure (not shown), or the lower part 13 of the container to be supported via the depression 17 by a bearer structure.

The depression 17 has a widened upper section 20 in which a plurality of upward-directed and slightly inward-inclined nozzles 21 are arranged for spraying the fluidized catalyst support material 23. Below the upper edge 22 of the depression 17, there is a cylindrical wall 24 which is followed further down by a deflection region which is formed partly by a height-adjustable closure body 25. In an opening position of the closure body indicated by broken lines, unfluidized material 26 can flow away in a downward direction along the inside wall of the depression 17.

A central tube 27 passes in the form of a bend through the superposed attachment 16 into the interior and then extends axially downward in the container 10 and ends shortly before the bottom of the bowl-like depression 17. The maximum distance from the bottom corresponds approximately to the radius of the central tube 27. Together with the cylindrical section 24 of the depression 17, the central tube delineates a cylindrical annular space 28. The outer end of the central tube 27 can be connected to the pressure side of a blower (not shown) which conveys air or another inert gas through the container 10.

Within the upper part 12 of the container, an annular deflection shield 29 which has a diameter D_{A} (here the width of the ring) and whose edge lies in a plane perpendicular to the axis 11 of the container, i.e. in a horizontal plane in the example depicted, is attached to the central tube 27. Between the deflection shield and the inside wall of the container 10, an annular opening 30 remains free, so that the gas can flow upward past the deflection shield 30 into the superposed attachment 16 which can be connected to the suction site of a blower (likewise not shown).

Within the lower part 13 of the container, a guide ring 31 is fastened to the central tube 27 by means of a number of ribs 32 so that it is concentric with the central tube 27. If desired, the guide ring 31 can also be fastened to the wall of the container 10. The guide ring 31 has a larger diameter than the central tube 27.

The diameter of the central tube 27 is preferably equal to or greater than the diameter of the bowl-shaped depression 17 in the cylindrical part 24.

In FIG. 1, H1 denotes the distance between the upper edge 34 of the guide ring 31 and the central axis 37 of the container. The height H2 of the guide ring is preferably from one third to two thirds of the distance H between the upper edge 22 of the depression 17 and the central axis 37 of the container (where H=H1+H2+H3). Between the bottom edge 33 of the guide ring 31 and the upper edge 22 of the depression 17, an annular first opening 34 having an open height H3 remains free so that the particulate material can pass under the force of gravity into the region of the nozzles 21 and into the region between the guide ring 31 and the central tube 27 where it is conveyed upward by fluidization. The guide ring can be installed so that its height can be adjusted. The distance L between the wall of the central tube 27 and the wall of the guide ring 31 is greater than the open height H3 of the first opening 34.

In addition, an annular second opening 36 remains free between the upper edge 35 of the guide ring 31 and the deflection shield 29, and the stream of fluidized particles is deflected through this.

The container 10 contains pulverulent, granular or shaped material which is mixed, dried or coated or subjected to a combination of two or more of these processes. In the figure, the material 26 is shown in the state of the unfluidized bed, while the material 23 represents the fluidized part of the material.

In operation, the blower mentioned draws air or an inert gas in a heated, dry state in the direction of the arrows in FIG. 1 through the apparatus depicted, with the pressure in the interior of the container being able to be below ambient pressure. At the same time or alternatively, solid, pulverulent or liquid materials are sprayed in through the nozzles 21. These materials deposit on the fluidized material 23 before they reach any wall of the apparatus. To minimize deposition of the sprayed-in materials on the central tube 27, the deflection shield 29, the guide ring 31 and the struts 32, these components have a 5 mm thick adhesion-reducing layer 38 of polytetrafluoroethylene.

The apparatus of the present invention is particularly useful for coating supported catalysts, for example catalysts for preparing phthalic anhydride. Conventional catalyst supports have the shapes of spheres, cylinders, rings or columns and have a particle size (diameter or length) of from 5 to 15 mm. Customary materials for producing the supports are corundum, alumina, silica gel or porcelain.

To coat the shaped catalyst supports, the bed of supports is fluidized by means of a stream of air, preferably at from 70 to 130° C., fed in via the downward-projecting tube 27. The active catalyst components are preferably sprayed as a solution or suspension, in particular an aqueous suspension, by means of the nozzles 21 onto the catalyst particles kept in motion in the fluidized bed. When aqueous suspensions are sprayed onto the supports, the water evaporates immediately on hitting the supports.

The invention is illustrated by the following examples.

### EXAMPLE 1

### Single-Layer Catalyst on Conventional Support Rings for the Synthesis of Phthalic Anhydride

47.44 kg of anatase (BET surface area=9 m²/g), 20.34 kg of anatase (BET surface area=20 m²/g), 5.32 kg of vanadium pentoxide, 1.33 kg of antimony oxide and 0.30 kg of cesium carbonate were suspended in 195 l of deionized water and the mixture was stirred for 18 hours to achieve a homogeneous distribution. 30.6 kg of organic binder comprising a copolymer of vinyl acetate and vinyl laurate in the form of a 50% strength by weight aqueous dispersion were added to this suspension.

In a fluidized-bed apparatus as shown in FIG. 1 provided with a guide ring having an internal diameter of 500 mm and a height H2=205 mm (H1=65 mm, H3=130 mm, H=400 mm, L=92.5 mm, DA=262.5 mm, DB=1000 mm), 60 kg of this suspension were sprayed onto 150 kg of steatite (magnesium silicate) in the form of rings having dimensions of 7 mm×7 mm×4 mm (external diameter×height×internal diameter) and dried. The outer wall of the central tube 27 from below the deflection shield 29 to the bottom edge of the guide ring and also the struts 32 had been coated with polytetrafluoroethylene (Teflon®) (coating thickness: 5 mm).

The operating parameters were:

Temperature of inflowing air: 109° C.

Temperature of outflowing air: 66° C.

Feed rate of suspension: 2.25 kg/min

Air flow: 6000 m³/h

The weight of the coating applied was 8.0% of the total weight of the finished catalyst. The catalytically active composition applied in this way, i.e. the catalyst shell, comprised 7.12% by weight of vanadium (calculated as V₂O₅), 1.8% by weight of antimony (calculated as Sb₂O₃), 0.33% by weight of cesium (calculated as Cs) and 90.75% by weight of titanium dioxide after calcination at 450° C. for one hour. The layer thickness was measured by scanning electrode microscopy (SEM). For this purpose, the samples were embedded in resin and parted by means of a diamond saw. The rings had been homogeneously coated with a layer having a thickness of 70-100 μm.

This uniform coating was also obtained in 15 successive coating processes between which no cleaning of the apparatus was necessary.

### COMPARATIVE EXAMPLE 2

Coating of the catalyst support was carried out as described in example 1, but the outer wall of the central tube 27 and the struts 32 had not been coated with Teflon.

After coating had been carried out 15 times, a 1 to 2 cm deposit of catalyst powder was found on the outer wall of the central tube. This deposit led to disturbances of the air flow in the vicinity of the nozzle (21) (e.g. in the opening 34), so that nonuniform coating of the steatite rings with the active composition resulted.

The fluidized-bed apparatus of example 2 therefore requires intensive cleaning after carrying out the coating procedures 7-8 times, which is time-consuming and leads to a reduction in the production capacity.

### EXAMPLE 3

In a fluidized-bed apparatus of the type described in example 1, in which the guide ring had an internal diameter of 500 mm and a height H2 of 255 mm (H3=80 mm), the same suspension (60 kg) as in example 1 was sprayed onto 150 kg of steatite in the form of rings having dimensions of 7 mm×7 mm×4 mm and dried. The coated catalyst obtained had the same composition as in example 1. The layer thickness was 70-100 μm and was homogeneous.

The results show that the active composition was applied uniformly to the support. In addition, no deposit was found in the coater.

### EXAMPLE 4

### Single-Layer Catalyst on Larger Support Rings

150 kg of steatite in the form of rings having dimensions of 8 mm×6 mm×5 mm were heated in a fluidized-bed apparatus as shown in FIG. 1 having a guide ring which had an internal diameter of 530 mm and a height H2 of 255 mm (H1=35 mm, H3=110 mm, L=107.5 mm) and sprayed with a suspension comprising 140.02 kg of anatase having a BET surface area of 21 m²/g, 11.776 kg of vanadium pentoxide, 31.505 kg of oxalic acid, 5.153 kg of antimony trioxide, 0.868 kg of ammonium hydrogenphosphate, 0.238 g of cesium sulfate, 215.637 kg of water and 44.808 kg of formamide together with 33.75 kg of an organic binder comprising a copolymer of acrylic acid/maleic acid (weight ratio=75:25) until the weight of the applied layer corresponded to 10.5 % of the total weight of the finished catalyst (after heat treatment at 450° C. for one hour). The catalytically active composition applied in this way, i.e. the catalyst shell, comprised on average 0.15% by weight of phosphorus (calculated as P), 7.5% by weight of vanadium (calculated as V₂O₅), 3.2% by weight of antimony (calculated as Sb₂O₃), 0.1% by weight of cesium (calculated as Cs) and 89.05% by weight of titanium dioxide

The outer wall of the central tube (27) from below the deflection shield (29) down to the bottom edge of the guide ring and also the struts (32) were coated with Teflon (layer thickness: 5 mm).

Operating parameters:

Temperature of inflowing air 97° C.

Temperature of outflowing air: 67° C.

Feed rate of suspension: 2.25 kg/min

Air flow: 6500 m³/h

The results show that optimization of the dimensions of the guide ring made homogeneous coating of larger rings (compared to example 1) possible. The active composition was applied uniformly to the support. The layer thickness was 100-200 μm. No deposit was found in the fluidized-bed apparatus.

### COMPARATIVE EXAMPLE 5

Coating of the catalyst support was carried out as described in example 4, but the outer wall of the central tube 27 and the struts 32 were not coated with Teflon.

After coating had been carried out 15 times, a 1 to 2 cm deposit of catalyst powder was found on the outer wall of the central tube, and this led to inhomogeneous layers on the coated catalyst.

### COMPARATIVE EXAMPLE 6

Coating of the catalyst support was carried out as described in example 4, but a guide ring having an internal diameter of 500 mm and a height H2 of 205 mm was installed (H1=65 mm, H3=130 mm, L=92.5 mm). The same suspension as in example 4 was sprayed onto 150 kg of steatite in the form of rings having dimensions of 8 mm×6 mm×5 mm and dried. The coated catalyst obtained had the same composition as that in example 4.

The results show that the active composition was not applied uniformly to the support. The layer thickness was not more than about 100 μm. In addition, from 10 to 20% by weight of abraded material were found.

### EXAMPLE 7

Coating of the catalyst support was carried out as described in example 4, but the guide ring had an internal diameter of 530 mm and a height H2 of 260 mm (H1=40 mm, H3=100 mm, L=107.5 mm). The same suspension as in example 4 was sprayed onto 150 kg of steatite in the form of rings having dimensions of 8 mm×6 mm×5 mm and dried. The coated catalyst obtained had the same composition as that in example 4.

The results how that the active composition was applied uniformly to the support. The layer thickness was 100-200 μm. In addition, no deposit was found in the fluidized-bed apparatus.

### EXAMPLE 8

### Single-Layer Catalyst on Conventional Support Rings for the Synthesis of Maleic Anhydride

6.1 m³ of isobutanol was placed in a stirred 8 m³ steel/enamel vessel which was provided with buffers and could be heated externally by means of pressure water and had been made inert with nitrogen. After starting up the three-stage impeller stirrer, the isobutanol was heated to 90° C. under reflux. At this temperature, the addition of 736 kg of vanadium pentoxide via the screw conveyor was commenced. After about ⅔ of the desired amount of vanadium pentoxide had been added after about 20 minutes, pumping in of 900 kg of 105% strength phosphoric aid was commenced while addition of vanadium pentoxide continued. To clean the pump, a further 0.2 m³ of isobutanol were pumped into the vessel. The reaction mixture was subsequently heated to about 100-108° C. under reflux and left under these conditions for 14 hours. The hot suspension was subsequently drained into a pressure filter which had previously been made inert with nitrogen and heated and filtration was carried out at about 100° C. and a pressure above the filter of up to 0.35 MPa abs. The filter cake was blown dry for about half an hour by passing nitrogen at 100° C. through it continually while stirring by means of a centrally located stirrer whose height could be adjusted. After blowing dry, the solid was heated to about 155° C. and the filter was evacuated to a pressure of 15 kPa abs (150 mbar abs). Drying was carried out to a residual isobutanol content of <2% by weight in the dried catalyst precursor.

The dried powder was subsequently treated in air for 2 hours in a rotating tube having a length of 6.5 m, an internal diameter of 0.9 m and internal helices. The speed of rotation of the tube was 0.4 rpm. The powder was fed into the rotating tube at a rate of 60 kg/h. The air flow into the tube was 100 m³/h. The temperature of the five equal-length heating zones measured directly on the outside of the rotating tube were 250° C., 300° C., 340° C., 340° C. and 340° C. After cooling to room temperature, the VPO precursor was intimately mixed with 1% by weight of graphite and compacted in a roller compactor. The fines having a particle size of <400 μm in the compacted material were sieved out and fed back into the compaction process. The coarse material having a particle size of >400 μm was mixed with a further 2% by weight of graphite and tableted in a tableting machine to give 5×3×2.5 mm hollow cylinders (external diameter×height×diameter of the central hole) having a lateral compressive strength of 11 N. To obtain the required amount of catalyst precursor, a number of batches were processed.

About 2.7 metric tons of the 5×3×2.5 mm hollow cylinders obtained were conveyed continuously in a bed height of 9-10 cm on a gas-permeable conveyor belt through a belt calcination apparatus comprising two identical belt calcination units connected in series and having a total of 8 calcination zones. The first 1.4 metric tons were used for setting the operating parameters of the belt calcination apparatus at the beginning. Since they did not constitute uniform material, they are not considered further in the following.

The belt calcination apparatus was operated at atmospheric pressure. Between the calcination zones 4 and 5, there was an encapsulated transition zone. Each of the 8 calcination zones were provided with a fan to generate gas circulation. Each of the 8 calcination zones was supplied with the desired amount of the desired fresh gas. To obtain the desired atmospheric pressure, an appropriate amount of gas was discharged. The volume of the gas circulated per unit time in each calcination zone was greater than the volume of the gas fed in or discharged per unit time. Between each two successive calcination zones there was in each case a dividing wall, which was open in the region of the stream of catalyst precursor, in order to reduce exchange of gas. The length of each calcination zone was 1.45 m. The speed of the conveyor belt was set so as to achieve the desired residence time of about 2 hours per calcination zone. The individual zones were operated as shown in table 1:

TABLE 1
Parameters for operation of the belt calcination apparatus

| Zone | Temperature | Fresh gas fed in |
|---|---|---|
| Calcination zone 1 | Heating to 250° C. | Air |
| Calcination zone 2 | Held at 250° C. | Air |
| Calcination zone 3 | Held at 250° C. | Air |
| Calcination zone 4 | Heating to 310° C. | Air |
| Transition zone | Cooling to 200° C. | Air |
| Calcination zone 5 | Heating to 425° C. | N₂ |
| Calcination zone 6 | Held at 425° C. | N₂/H₂O vapor (1:1) |
| Calcination zone 7 | Held at 425° C. | N₂/H₂O vapor (1:1) |
| Calcination zone 8 | Cooling to room temperature | N₂ |

In this way, about 1.3 metric tons of finished catalyst were produced continuously. A representative average sample of this catalyst had the following data:
* mean oxidation state of the vanadium (Vₒₓ): 4.15
* mean BET surface area (m²/g): 25
* lateral compressive strength (LCS): 9.4 N

150 kg of the calcined precursor were admixed with 3.8 l of deionized water. 30.6 g of molybdenum acetylacetonate were added to this suspension. The suspension was milled overnight in a ball mill (6 balls having a diameter of 35 mm, 5 balls having a diameter of 30 mm and 2 balls having a diameter of 25 mm). 300 g of polyvinyl acetate dispersion (Vinnapas dispersion LL8550, solids content 50%) were then added. The mixture was milled for a further 30 minutes. The suspension was transferred to a glass vessel and made up to about 7.5 l.

150 kg of supports (steatite rings from Aluminagres having the geometry 3.7 mm×2.7 mm×2.05 mm) (external diameter×height×internal diameter) were placed in a fluidized-bed apparatus as shown in FIG. 1 having a guide ring which had an internal diameter of 500 mm and a height 205 mm. Over a period 3 hours, the suspension was sprayed onto the support rings and dried. The proportion of active composition was 49.4% by weight (determined by burning off the organic compounds at 400° C. in air). The outer wall of the central tube (27) below the deflection shield (29) down to the bottom edge of the guide ring and also the struts (32) are coated with Teflon (thickness: 5 mm) (as in example 1).

Operating parameters:

Temperature of inflowing air 109° C.

Temperature of outflowing air: 66° C.

Feed rate of suspension: 2.25 kg/min

Air flow: 6000 m³/h

The results show that the active composition was applied uniformly to the supports. The layer thickness is 600-750 μm and is homogeneous on the rings. In addition, no deposit was found in the fluidized-bed apparatus or on the outer wall of the central tube or the struts.

1. An apparatus for coating pulverulent, granular or shaped loose material in a fludized bed, which comprises
a container (10) for accommodating the loose material, with a bowl-like depression (17) being provided in a lower region (13) of the container,
a central tube (27) for introducing a gas, with the central tube entering the container in an upper region (12) of the container and extending essentially axially downward in the container and opening into the depression, wherein at least a portion of the outer wall of the central tube includes an adhesion-reducing coating (38),
a substantially annular deflection shield (29) which is fixed to the central tube in the upper region of the container,
a guide ring (31) which is located in the lower region of the container and surrounds the central tube concentrically at a distance (L) for part of its length so that a first opening (34) is formed between the wall of the container at the upper edge (22) of the depression and the lower end (33) of the guide ring and a second opening (36) is formed between the deflection shield (29) and the upper edge (35) of the guide ring.

2. An apparatus as claimed in claim 1, wherein the outer wall of the central tube is provided with the adhesion-reducing coating below the deflection shield.

3. An apparatus as claimed in claim 1, wherein the guide ring is fixed to the central tube by struts (32) which are provided with the adhesion-reducing coating.

4. An apparatus as claimed in claim 1, wherein the underside of the deflection shield, the inside wall of the guide ring or both are provided with the adhesion-reducing coating.

5. An apparatus as claimed in claim 1, wherein the adhesion-reducing coating is a polymer of a fluorinated, ethylenically unsaturated hydrocarbon.

6. An apparatus as claimed in claim 5, wherein the adhesion-reducing coating is a perfluorinated fluoropolymer.

7. An apparatus as claimed in claim 1, wherein the distance (L) between the wall of the central tube and the wall of the guide ring is greater than the open height (H3) of the first opening (34).

8. An apparatus as claimed in claim 1, wherein the distance (L) between the wall of the central tube and the wall of the guide ring is less than ⅔ of the diameter (D_{A}) of the deflection shield.

9. An apparatus as claimed in claim 7, wherein the distance (L) is determined by the dimension of the loose material, wherein the larger the loose material the greater the distance (L).

10. An apparatus as claimed in claim 1 wherein the height (H2) of the guide ring is in the range from one third to two thirds of the distance (H) between the upper edge (22) of the depression and the central axis of the container.

11. An apparatus as claimed in claim 1, wherein the diameter of the guide ring corresponds essentially to half the diameter of the container.

12. A method of producing supported catalysts, which comprises fluidizing the catalyst supports in an apparatus as claimed in claim 1 and coating them by spraying them with a catalyst-containing suspension.

13. An apparatus as claimed in claim 4, wherein the distance (L) between the wall of the central tube and the wall of the guide ring is greater than the open height (H3) of the first opening (34).

14. An apparatus as claimed in claim 7, wherein the distance (L) between the wall of the central tube and the wall of the guide ring is less than ⅔ of the diameter (D_{A}) of the deflection shield.

15. An apparatus as claimed in claim 7, wherein the height (H2) of the guide ring is in the range from one third to two thirds of the distance (H) between the upper edge (22) of the depression and the central axis (37) of the container.

16. An apparatus as claimed in claim 8, wherein the height (H2) of the guide ring is in the range from one third to two thirds of the distance (H) between the upper edge (22) of the depression and the central axis (37) of the container.

17. An apparatus as claimed in claim 1 further comprising a means for introducing a fluid into the container.

18. An apparatus as claimed in claim 1 further comprising fluid inputs proximate to the depression for introducing a fluid into the container.

19. A supported metal oxide catalyst prepared by a process comprising:
fluidizing catalyst support in a fluidized bed apparatus while adding a suspension of TiO₂, V₂O₅ and Sb₂O₃ particles to the apparatus thereby treating the catalyst support with the suspension of particles, wherein the apparatus comprises:
a container (10) with a bowl-like depression (17) being provided in a lower region (13) of the container,
a central tube (27) for introducing a gas, the central tube extending essentially axially downward in the container and opening into the depression,
a substantially annular deflection shield (29) which is fixed to the central tube in the upper region of the container,
a guide ring (31) which is located in the lower region of the container and surrounds the central tube concentrically at a distance (L) for part of its length so that a first opening (34) is formed between the wall of the container at the upper edge (22) of the depression and the lower end (33) of the guide ring and a second opening (36) is formed between the deflection shield and the upper edge (35) of the guide ring, wherein the outer wall of the central tube is at least partly provided with an adhesion-reducing coating; and
heating the treated catalyst support to provide the supported metal oxide catalyst with a catalyst coat thickness of 70 μm to 200 μm.
